(19) United States
(12) Patent Application Publication
(10) Pub. No.: US 2010/0038313 A1
(43) Pub. Date: Feb. 18, 2010

(54) METHOD FOR PURIFYING SIALYLLACTOSE BY CHROMATOGRAPHY

(75) Inventor: Stanislas Baudouin, Aubergenville (FR)

Correspondence Address: HARNESS, DICKEY & PIERCE, P.L.C., P.O. BOX 828, BLOOMFIELD HILLS, MI, 48303, US

(73) Assignee: APPLEXION, Epone (FR)

(21) Appl. No.: 12/447,742

(22) PCT Filed: Oct. 30, 2007
(86) PCT No.: PCT/FR07/01801

§ 371 Date: Apr. 29, 2009

(30) Foreign Application Priority Data
Oct. 30, 2006 (FR) 06 09 528

(51) Int. Cl. B01D 15/36

(52) U.S. Cl. 210/635

(57) ABSTRACT

The application relates to a method for purifying sialyllactose by ion-exclusion chromatography of a solution containing the sialyllactose on a mainly manovalent strong cationic resin, Na or K, and obtaining a sialyllactose-enriched raffinate.

### CROSS-REFERENCE TO RELATED APPLICATIONS

This application is a National Phase Entry of International Application No. PCT/FR2007/001801, filed Oct. 30, 2007, which claims priority to French Patent Application No. 0609528, filed Oct. 30, 2006, both of which are incorporated herein by reference.

### FIELD OF THE INVENTION

The object of the present invention is a method for purifying sialyllactose by chromatography of a solution containing sialyllactose on a fixed bed of specific resin.

### STATE OF THE ART

Sialyllactose has a role of controlling pathogenic bacteria; risks of infection may be reduced with it. A recent study has moreover shown that sialyllactose reduces the risk of contamination by the HIV. Sialyllactose is formed by association between sialic acid and lactose. This compound of empirical formula C₂₃H₃₉NO₁₉ (MW 633) is represented by the following formula (sialyllactose has a carboxylic acid function):

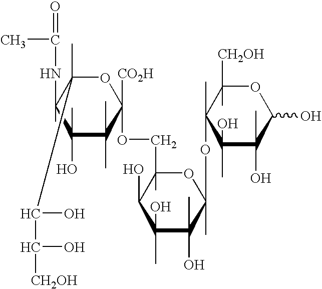

Its concentration in milk is given as an indication in the table below.

| Milk | Colostrum | Milk | Long lactation milk |
|---|---|---|---|
| Human | 1018+/229 | 365 +/− 245 | Not determined |
| Bovine | 231+/75 | 33 +/− 8 | 54 +/− 18 |

Human milk therefore contains much more sialyllactose than bovine milk. Infant milks produced from bovine milk are therefore much less rich than human milk and so they do not protect as efficiently against pathogenic bacteria as mothers's milk. Thus, it would useful to be able to complete infant milk with sialyllactose and in order to do this, it would be of interest to have a source of sialyllactose.

Many patents or publications propose the use of enzymes or bacteria stemming from genetic engineering in order to enrich milk in sialyllactose, so that a solution rich in sialyllactose may be obtained. However, sialyllactose is not of a natural origin in this case.

The separation between lactose and sialyllactose was carried out on whey after delipidation, with a separation by molecular sieve with Sephadex G50 resin. This separation is certainly efficient but the adsorbant used is expensive and more suitable for research use in the laboratory rather than for a separation at an industrial scale.

The application US2004/0185146 describes a method which consists of demineralizing whey and recovering sialyllactose on an anionic resin, after decationization on a cationic resin. This method involves a high consumption of reagent, since the whey is totally demineralized by the method. Thus, there exists a need for a method for purifying sialyllactose which may be used at an industrial scale and which provides good yields.

### SUMMARY OF THE INVENTION

It has now been shown that by using a particular resin in a chromatographic separation method, sialyllactose may be efficiently separated. The invention therefore provides a method for purifying sialyllactose by ion exclusion chromatography of a solution containing sialyllactose on a strong cationic resin in predominantly monovalent form, Na or K, and for obtaining a raffinate enriched in sialyllactose.

According to one embodiment, the resin is a resin of the sulfonated polystyrene divinylbenzene type. According to one embodiment the temperature is comprised between 0 and 80° C.

According to one embodiment, the method comprises a preliminary step of separating all or part of the calcium phosphate. According to one embodiment, the method comprises a preliminary step of substituting divalent ions with monovalent ions, in particular substituting calcium ions with sodium or potassium ions. According to one embodiment, the method comprises a preliminary nanofiltration step. According to one embodiment, the method comprises a subsequent step of concentrating the thereby obtained raffinate.

According to one embodiment, the solution containing sialyllactose is whey, whey permeate, milk, lactose crystallization mother liquors. According to one embodiment, the method comprises a preliminary step of separating the proteins from the solution containing sialyllactose, notably by ultrafiltration. According to one embodiment, the method is applied continuously with multiple columns. According to one embodiment, the method comprises a step of substituting divalent ions with monovalent ions and then a concentration step by nanofiltration, the ion exclusion chromatography step and a step of concentrating the raffinate on membranes.

The object of the invention is also a method for enriching humanized milks by adding sialyllactose, comprising the production of sialyllactose by the method according to the invention and the addition of the thereby obtained sialyllactose to humanized milk or a precursor of this humanized milk. The invention is also therefore directed to humanized milks obtained by adding sialyllactose obtained by the method. The object of the invention is further a device for purifying sialyllactose comprising at least one decalcification unit, at least one nanofiltration unit and at least one chromatography unit, for applying the method according to the invention.

### SHORT DESCRIPTION OF THE DRAWINGS

FIG. 1 shows an elution profile in a column filled with a strong cationic resin;

FIG. 2 shows an internal concentration profile in the columns of an installation applying the method according to the invention; and

FIG. 3 schematically shows an embodiment of the invention.

### DETAILED DESCRIPTION OF EMBODIMENTS OF THE INVENTION

The invention generally applies to all milk fractions containing sialyllactose, in particular whey. Also, with the invention, it is possible to separate sialyloligosaccharides, in particular sialyllactose.

Generally, whey appears under two large categories:
Mild whey: also called cheese-making whey, it is produce during elaboration of cheeses obtained by means of rennet. The pH of mild whey may typically vary from 5.2 to 6.7.
Acid whey: These are byproducts of the elaboration of casein, quark or fresh cheese. Casein whey stems from the making with coagulation by lactic acid or hydrochloric acid. Natural fermentation produces lactic acid, provides whey with high acidity. The pH of this product range typically is from 3.8 to 4.6.
   The invention applies to both types of whey described above and generally to dairy products which are solutions containing sialyloligosaccharides, in particular sialyllactose. Examples of such solutions are from cheese making whey, whey permeate, milk, lactose crystallization mother liquors.

The method is based on the discovery that sialyllactose may be notably purified by ion exclusion chromatography by using a sulfonated polystyrene divinylbenzene cationic resin. Sialyllactose is separated from lactose which is the primary constituent (80%) of whey and is found with the ionized molecules and macromolecules present in whey. By removing lactose, the purity of sialyllactose may be multiplied by 5.

The separation principle is based on two complementary chromatographic phenomena, which are achieved on the resin substantially simultaneously:
by virtue of its polystyrene divinylbenzene matrix, the resin adsorbs the molecules having a low molar mass such as lactose, but excludes high molar masses such as sialyllactose. Therefore, there is a size exclusion effect (size exclusion chromatography);
by virtue of its ionization, the resin excludes ionized molecules, such as sialyllactose, the acid function of which is dissociated at the pH of whey. There is therefore an ion exclusion effect (ion exclusion chromatography). The method is applied, the resin being in predominantly monovalent form, Na or K.

The combination of two chromatographic effects provides good purification efficiency, without using any reagent for regenerating the adsorbent, by using a very inexpensive adsorbent compatible with food use of sialyllactose. With the invention, it is therefore possible to separate whey into substantially two fractions, the first fraction containing lactose and the second fraction containing sialyllactose, the ionized molecules and macromolecules.

The resin used is a sulfonated polystyrene divinylbenzene resin. Any polystyrene gel resin cross-linked with divinylbenzene may be used. The divinylbenzene (DVB) level will typically been comprised between 2 and 16%, preferentially between 4 and 8% and more preferentially between 5 and 6%. The resin is a strong cation exchanger resin, used in elution in a ionized form, the cation may be Na or K. The strong cationic resin is in its predominantly monovalent form, i.e. more than 50% of the total capacity of the total resin is in the ionized form, Na or K, for example more than 70%, notably more than 90%. Examples of resins are the following: Diaion UBK 550, Diaion UBK530, Dowex 99/310, 99/320, 99/350, Lanxess MDS 1368, Rohm&Haas CR1320, Rohm&Haas CR1310.

The chromatography according to the invention may be continuous, discontinous (batchwise) or sequential (in particular known as SSMB). The invention may be applied on a single column or in a multi-column device, multi-column devices being preferred here. The SMB (Simulated Moving Bed) technology has been known for a long time, and is notably the object of the following patents U.S. Pat. No. 2,957,927, U.S. Pat. No. 2,985,589, U.S. Pat. No. 3,205,166, U.S. Pat. No. 3,291,726 and U.S. Pat. No. 3,310,486 (UOP). Columns with variable chromatographic lengths may also be used in the invention. Thus, the invention may be applied in a so-called Varicol® system, developed by the applicant, and corresponding to the U.S. Pat. No. 6,136,198, U.S. Pat. No. 6,375,839, U.S. Pat. No. 6,712,973, U.S. Pat. No. 6,413,419 and WO 00/25885 patents. The invention may also be applied in a so-called Cyclojet® system, itself also developed by the applicant, and corresponding to the U.S. Pat. No. 5,630,943 and WO 97/20206 patents, as well as to U.S. Pat. No. 6063284 and WO 98/51391. Any other chromatographic method, including batch chromatography, whether it be multi-column chromatography or not, may be used; systems known as ModiCon® and PowerFeed® may be mentioned, as well as two zone SMB chromatography.

The eluent used in the methods is any eluent capable of being used in the food industry; in particular it is water. The pH at which the method is applied varies in the pH range from 0 to 12, preferentially, it is comprised between 5 and 7. The temperature at which the method is applied may be comprised between 0° C. and 80° C., notably for example at about room temperature. The pressure is such that the operation is generally performed in a liquid phase.

Sialyllactose is efficiently separated by (advantageously continuous) chromatography of lactose. However, the strong calcium phosphate concentration in the whey may risk precipitating in the separator. Thus, depending on the case, the invention involves a preliminary step of pre-treating whey in order to remove all or part of the calcium phosphate in the whey. Notably, the divalent ions may be exchanged with monovalent ions, and it is thus possible to increase the sialyllactose content in the entire permeate.

As an exemplary pre-treatment, the methods which are the subject-matter of applications WO 99/04903 and WO 2004/022787, WO 2004/022788 and WO 2004/022789, may be mentioned. In particular, the step of exchanging or substituting calcium phosphate makes use of a cationic resin, the counter-ion of which is a monovalent metal cation, such as a sodium or potassium ion for example. It is also possible to proceed, before or after substituting the cations, with substituting bivalent anions with monovalent (for example chloride) anions under the conditions described in the above applications.

It is further possible to proceed with a concentration by nanofiltration on membranes, in order to remove the monovalent salts and to concentrate the carbohydrates. The different flows may be treated in order to be recycled into the process. The raffinate containing sialyllactose which is obtained by the method according to the invention may be concentrated according to standard techniques, for example by clarification with membranes, a pre-layer filter, nanofiltration, etc. It is possible to proceed with ion exchange as described above on the raffinate obtained by the method according to the invention.

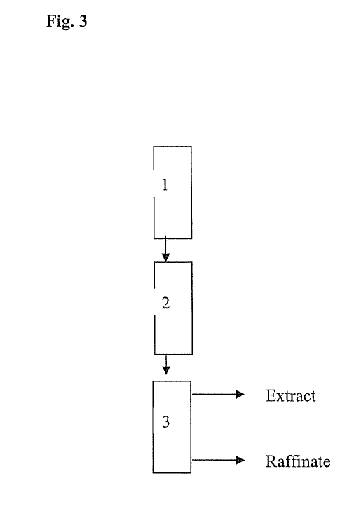

FIG. 3 illustrates an installation making use of the preliminary technique of substituting divalent cations with monovalent cations, in particular substituting calcium phosphate with sodium or potassium phosphate. The installation then comprises a unit 1 for exchanging divalent ions with monovalent ions, chloride and sodium or potassium ions. The flow is treated by nanofiltration on membranes in the unit 2. The outgoing flow is sent to the chromatographic separation 3. This unit 3 for example comprises 6 columns. An extract and a raffinate are obtained.

Finally, the object of the invention is the application of the method for preparing sialyllactose for its use in humanized milk. Humanized milks are notably described in document EP-A-0302807. The following examples illustrate the invention without limiting it.

### Examples

### Example 1

### Elution Chromatography

A column with a diameter of 2.5 cm and a length of 100 cm is used, filled with Diaion UBK 530 resin equilibrated beforehand with whey. The temperature is maintained at 60° C. by a water bath. The circulation flow rate is 600 mL/h.

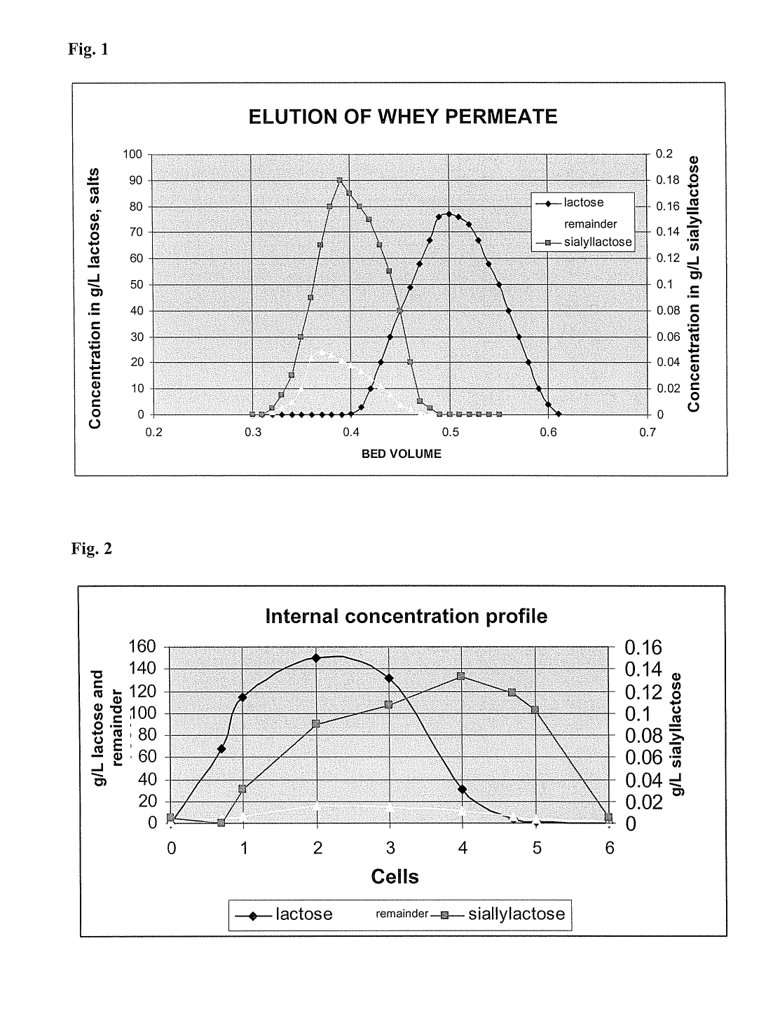

20 mL of whey permeate are introduced into the column and then eluted with water. The sialyllactose concentration in the whey permeate is about 150 mg/L. The effluent of the column is fractionated and the lactose, the sialyllactose and the total dry material are analyzed. The elution curve is given in FIG. 1. BV means Bed Volume or volume of the bed. If the fraction from 0.32 to 0.42 BV is collected, 75% of the incoming sialyllactose is recovered, and the purity of sialyllactose passes from 0.15% based on dry material to a purity of 0.62% based on dry material. The lactose is mainly found in the fraction from 0.42 to 0.63 BV. The table below groups the values together (% dm being % based on dry matter).

| Fraction | Sialyllactose % dm | Lactose % dm | Remainder % dm |
|---|---|---|---|
| 0.32-0.42 | 0.66 | 7.77 | 91.56 |
| 0.42-0.62 | 0.04 | 97.03 | 2.93 |

### Example 2

### Continuous Chromatography

A pilot installation consisting of 6 columns of size identical with that of Example 1, operating according to a continuous process of the SSMB (Sequential Simulated Moving Bed) type, is used. The temperature is maintained at 60° C. The whey is concentrated to 20% dry matter and filtered. An extract and a raffinate are thereby recovered. The extract contains the material which is the most retained on the resin, while the raffinate contains the least retained product. Sialyllactose is found in the raffinate. The internal concentration profile is given in FIG. 2. The table below groups the values together (% dm being % based on dry matter).

| Fraction | Sialyllactose % dm | Lactose % dm | Remainder % dm |
|---|---|---|---|
| Raffinate | 1.18 | 41.93 | 56.89 |
| Extract | 0.01 | 93.71 | 6.28 |

The continuous method enables an efficient separation between sialyllactose and lactose, the purity of sialyllactose reaches 1.18% and the recovery yield 98%.

### Example 3

### Installation with Ion Separation

The installation described in FIG. 3 is applied. The whey which is the feed flow for the ion exchange resins comprises a dry material content of 6%, including 80.56% lactose and 0.30% sialyllactose. After ion exchange, the profile of the flow is not substantially modified, except for the lactose content which is then 80.16%. After nanofiltration, the retentate is a flow then comprising 24% dm, including 90.45% lactose and 0.32% sialyllactose. This solution is treated in an SSMB installation (available from Applexion, Epone, France). The resin used is a resin of the Diaion UBK 550, Diaion UBK530, Dowex 99/310, 99/320, 99/350, Lanxess MDS 1368, Rohm&Haas CR1320 or even Rohm&Haas CR1310 type. Process water is used as an eluent. For a solution flow rate to be treated of 20 L/h, a water flow rate of about 85 L/h is used. The extract (about 45 L/h) then contains 10.06% dm including 99.22% lactose and 0.02% sialyllactose, while the raffinate (about 60 L/h) then contains 0.93% dm, including 16.97% lactose and 2.88% sialyllactose.

1.-12. (canceled)

13. A method for purifying sialyllactose by ion exclusion chromatography of a solution containing sialyllactose on a strong cationic resin in predominantly monovalent form, Na or K, and for obtaining a raffinate enriched in sialyllactose.

14. The method according to claim 13, wherein the resin is a sulfonated polystyrene divinylbenzene type.

15. The method according to claim 14, wherein the temperature is comprised between 0 and 80° C.

16. The method according to 15, comprising a preliminary step for separating all or part of the calcium phosphate.

17. The method according to any of claim 16, comprising a preliminary step of substituting divalent ions with monovalent ions, in particular substituting calcium ions with sodium or potassium ions.

18. The method according to claim 17, comprising a preliminary nanofiltration step.

19. The method according to claim 18, comprising a subsequent step of concentrating the thereby obtained raffinate.

20. The method according to claim 19, wherein the solution containing sialyllactose is whey, whey permeate, milk, lactose crystallization mother liquors.

21. The method according to claim 20, comprising a preliminary step of separating proteins from the solution containing sialyllactose, notably by ultrafiltration.

22. The method according to claim 21, which is applied continuously with multiple columns.

23. The method according to claim 22, comprising a step of substituting divalent ions with monovalent ions and then a concentration step by nanofiltration, the ion exclusion chromatographic step and a step of concentrating the raffinate on membranes.

24. A method for enriching humanized milks by adding sialyllactose comprising the production of sialyllactose by performing ion exclusion chromatography of a solution containing sialyllactose on a strong cationic resin in predominantly manovalent form, NA or K, and obtaining a raffinate enriched in sialyllactose; followed by the addition of the thereby obtained sialyllactose to a humanized milk or a precursor of this humanized milk.
